(19) United States
(12) Patent Application Publication
(10) Pub. No.: US 2018/0082612 A1
(43) Pub. Date: Mar. 22, 2018

(54) Interchangeable Shelf Label System

(71) Applicant: Already, LLC, Arlington, TX (US)

(72) Inventors: John P. McDade, Fort Worth, TX (US); John P. McDade, JR., Fort Worth, TX (US)

(21) Appl. No.: 15/709,166

(22) Filed: Sep. 19, 2017

Related U.S. Application Data
(60) Provisional application No. 62/396,788, filed on Sep. 19, 2016.

(51) Int. Cl. G09F 3/20; G09F 3/02

(52) U.S. Cl. CPC G09F 3/201; G09F 3/02

(57) ABSTRACT

An interchangeable shelf label system includes a label mount backing plate, a label sleeve, and a label plate for securing to shelving. The label mount backing plate has a configured thickness and extends from the distal end of one or more support arms of shelving and presents a front face as a backing surface for the label plate.

The label sleeve includes ridges, extending inwardly from the interior front wall of the label sleeve a target width, with ridges disposed on opposing sides of the label sleeve. The label sleeve further includes ledges, opposing the ridges, the ledges disposed on opposing sides of the label sleeve. The ledges extend inwardly a target width from the ridges. The ledge to ridge area define a first sleeve dimensioned for receipt of the label mount backing plate. The ridge to interior wall area define an adjacent, second sleeve dimensioned for receipt of the label plate. The adjacent sleeve enables the label mount backing plate and the label plate to be simultaneously slidably engaged for an optimum compression fit.

### BACKGROUND

### Field Of The Invention

The invention relates generally to shelf systems and more particularly to shelf display systems.

### Description Of The Related Art

In the merchandising of products in stores, merchandise is often displayed on shelves, where the items can be easily seen by customers and easily removed for placement in shopping carts or the like. It is conventional to secure label display stickers to the front of such shelves, to display pricing information and/or other information of relevance to a prospective consumer. Often, the retailer desires to highlight certain items in a manner that will catch the consumer's attention. Typical methods of highlighting selected products involve attaching adhesive labels to the front of the label holder with the information on the label facing a consumer as he or she walks along a store aisle, such as that shown in the prior art figure. An example display structure includes shelf-type structures having shelf-type price label holders such as that shown in the prior art figure.

The rear end is slid through a channel and a sticker with the display information is placed on the front face. When it is necessary to change product information, the sticker is removed from the front face, taking time and energy.

### SUMMARY

Embodiments of an interchangeable shelf label system include a label mount backing plate, a label sleeve, and a label plate for securing to shelving. The label mount backing plate extends from the distal end of one or more support arms, with the proximal ends of the support arms extending from shelving and the label mount backing plate presenting a front face as a backing surface for the label plate. The label mount backing plate has a configured thickness for slidable engagement in the label sleeve.

The label sleeve includes an upper section, a lower section, a front section and a rear section. The label sleeve includes ridges, extending inwardly from the interior front wall of the label sleeve a configured target length, with the ridges disposed on opposing sides of the label sleeve. The label sleeve further includes ledges, opposing the ridges, the ledges disposed on opposing sides of the label sleeve. The ledges extend inwardly a configured target distance from the ridges. The ledge to ridge area define a first sleeve dimensioned for receipt of the label mount backing plate. The ridge to interior wall area define an adjacent, second sleeve dimensioned for receipt of the label plate. The adjacent sleeve enable the label mount backing plate and the label plate to be simultaneously slidably engaged.

The label plate has a configured thickness. The configured target dimensions and material compositions of the label mount backing plate, first sleeve, label plate, and the second sleeve are selected to result in an optimum compression fit such that the label plate can be slidably engaged and disengaged by hand force while preventing accidental dislodging.

These and other features, aspects, and advantages of the invention will become better understood with reference to the following description, and accompanying drawings.

### BRIEF DESCRIPTION OF THE DRAWINGS

FIG. 1 depicts an embodiment of an interchangeable shelf label system as it may exist in operation;

FIG. 2 depicts the parts of an embodiment of an interchangeable shelf label system as it may exist in operation;

FIG. 3 depicts a top view of parts of an embodiment of an interchangeable shelf label system as it may exist in operation;

FIGS. 4A and 4B depict top views of parts of embodiments of interchangeable shelf label systems as they may exist in operation;

FIGS. 5A and 5B depict front perspective views of usage of embodiments of interchangeable shelf label systems as they may exist in operation;

FIG. 6 depicts a top perspective view of an embodiment of an interchangeable shelf label system as it may exist in operation; and

FIG. 7 depicts a prior art shelf label display.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

As mentioned, it is conventional to secure label display strips to the front of such shelves, to receive and display pricing and other information of relevance to a prospective consumer. Often the retailer desires to highlight certain merchandise in a manner that will catch the consumer's attention. Additionally, a retailer often seeks high turnover frequency of the shelf space, thus the ability to quickly and uniquely label all sections of the shelf space is desirable. A consistent problem with the use of conventional labels arises after the label has served its purpose and is no longer needed.

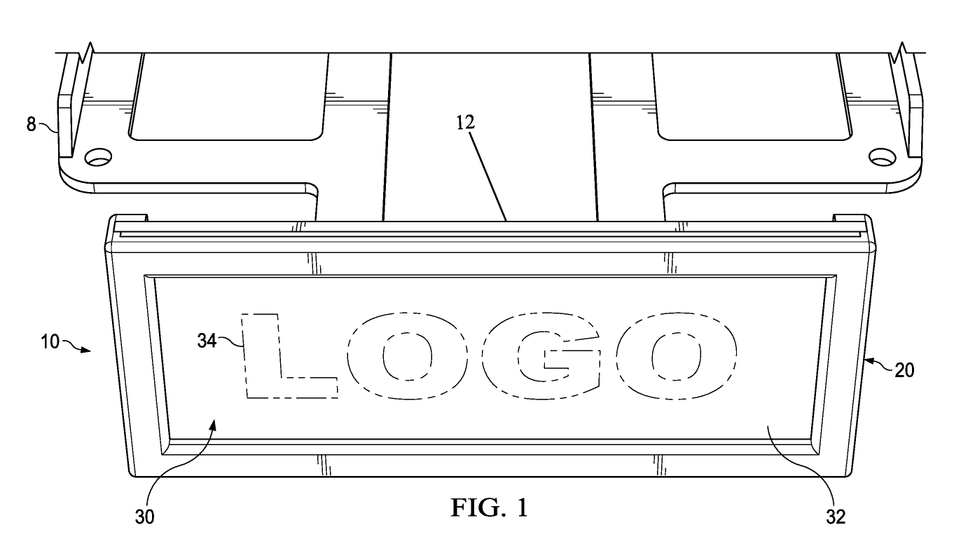

The present invention is directed to an interchangeable shelf label system 10. FIG. 1 illustrates an embodiment of an interchangeable shelf label system 10 of the present invention as it may exist in usage. Depicted are a label backing plate 12, a label sleeve 20, and a label plate 30.

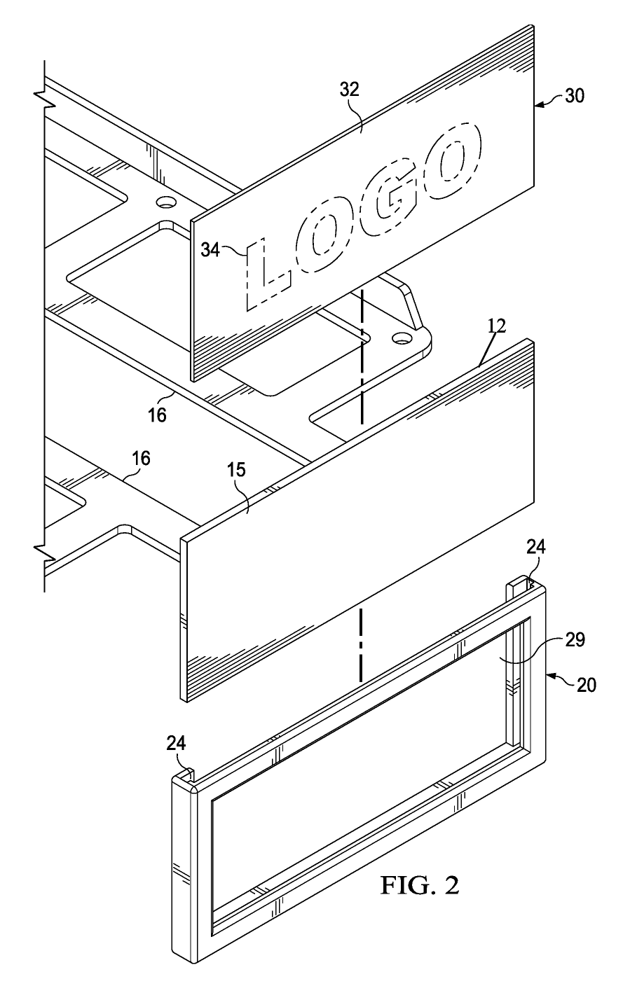

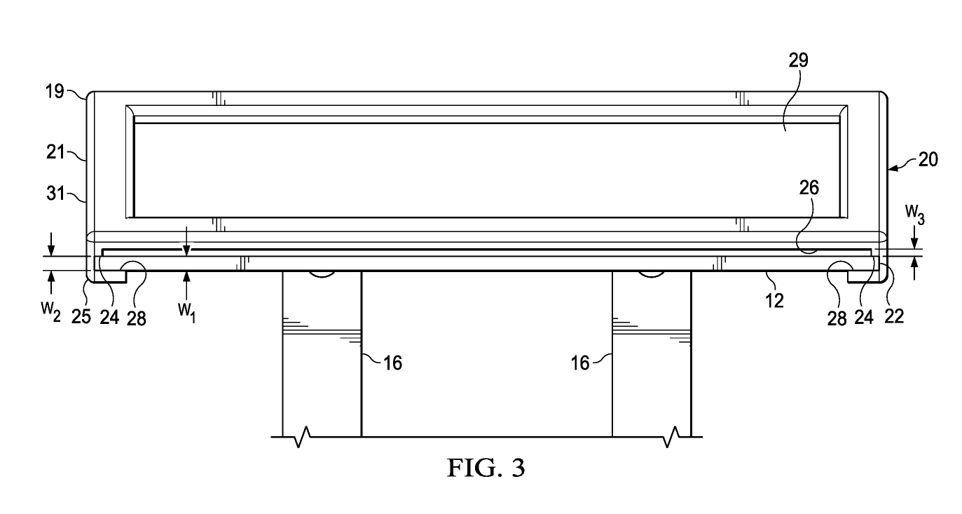

Certain embodiments of the invention include a label mount backing plate 12, operable to support the interchangeable shelf label system 10 and provide a backing support surface for the label plate 30. FIGS. 2 and 3 illustrate configurations of a label mount backing plate 12. The illustrated label mount backing plate 12 extends from the distal end of one or more support arms 16, with the proximal ends of the support arms 16 extending from shelving 08. The illustrated label mount backing plate 12 presents a front face 15 having a surface area presenting a backing surface for the label plate 30, conforming to at least a portion of the rear surface of the label plate 40. An exemplary front face 15 is substantially planar. The front face 15 can angularly depend from the support arms 16, with representative suitable angles being about 70° to 100° relative to the support arms 16. The label mount backing plate 12 has a configured thickness W1 for slidable engagement into the label sleeve 20, as will be disclosed.

FIG. 3 illustrates a configuration of a label sleeve 20. The label sleeve 20 is operable is to slidably receive the label mount backing plate 12 and the label plate 30 simultaneously in order to resiliently secure the interchangeable shelf label system 10, employing a compression fit approach, in exemplary configuration. The label sleeve 20 is composed of rigid materials, including plastics and polymers, such as rigid polyvinyl chloride, ultramid polyamide, glass-filled ultramid polyamide, or others. The label sleeve 20 includes an upper section 21 and a lower section 19. The label sleeve 20 includes a front section 31 and a rear section 25.

In certain configurations, the front section 31 of the label sleeve 20 includes an opening presenting a window 29. In certain configurations, the label sleeve 20 or the front section 31 is composed of a transparent material, such as a polymer or plastic. The window 29 or transparency enable visibility of the insignia 34 region while the device is in operation, such that the front face 32 or section thereof can be clearly viewed.

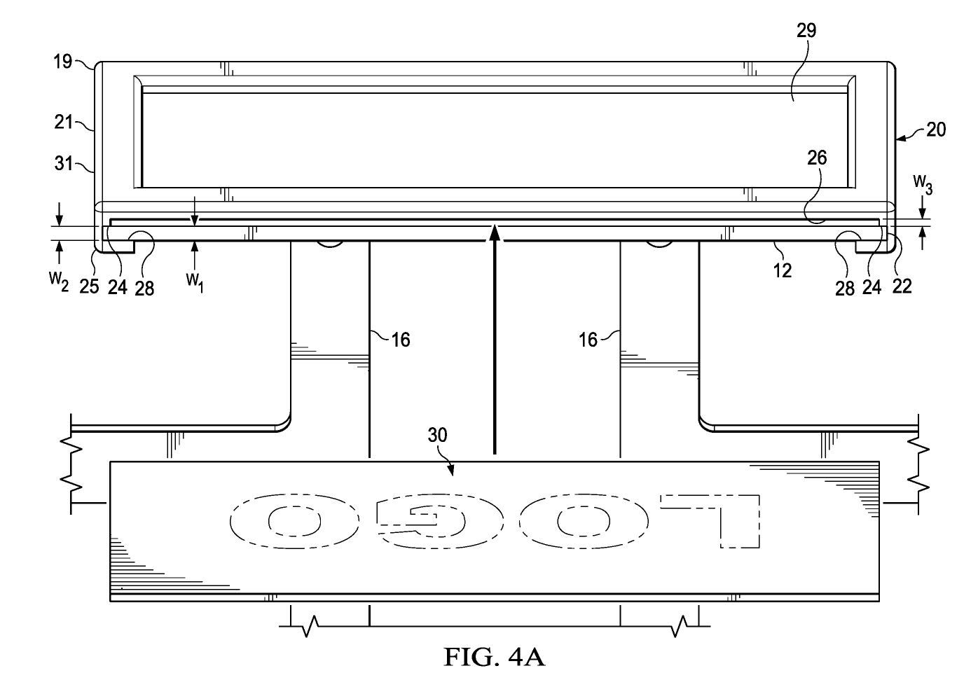

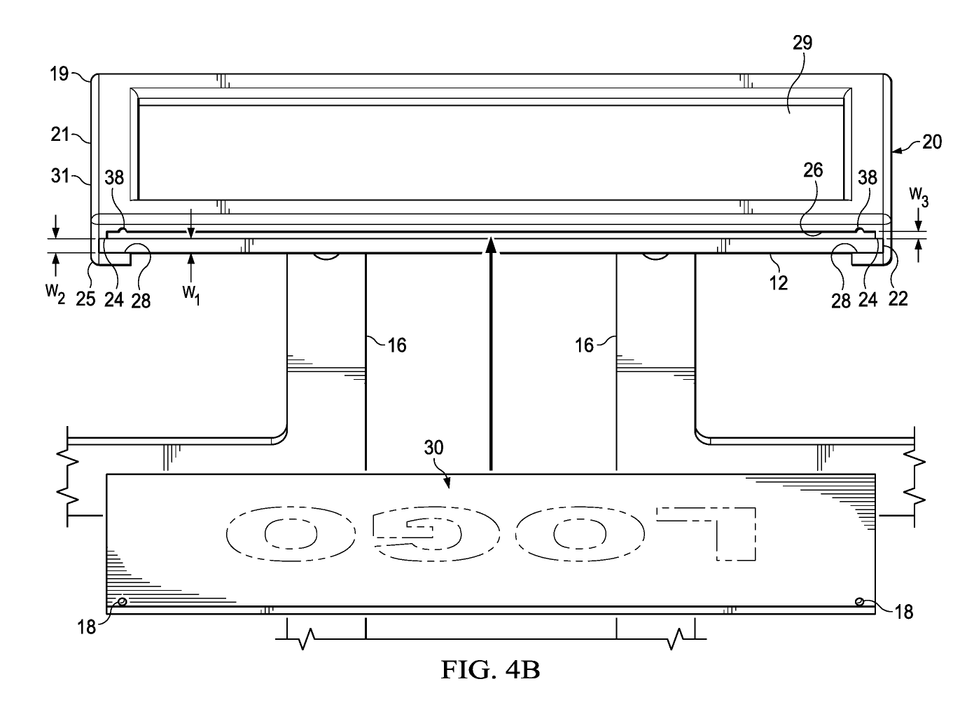

The illustrated label sleeve 20 of FIG. 4A includes ridges 24 extending from the upper section 21 of the label sleeve 20 to the lower section 19 of the label sleeve 20, the ridges 24 disposed on opposing sides of the label sleeve 20. In other configurations, the ridges 24 have a shorter height, not extending from the upper section 21 to the lower section 19. The ridges 24 extend inwardly from the interior front wall of the label sleeve 20 a length of W3. The illustrated label sleeve 20 also includes ledges 28 extending from the upper section 21 of the label sleeve 20 to the lower section 19 of the label sleeve 20, the ledges 28 disposed on opposing sides of the label sleeve 20. In other configurations, the ledges 28 have a shorter height, not extending from the upper section 21 to the lower section 19. The ledges 28 are further distal to the ridges 24 from the interior front wall and also extend inwardly a distance of W2 from the ridges 24.

The area bounded laterally by the ledge 24 to ridge 28 on the same side of the label sleeve 20, from opposing ledges 24, and from opposing ridges 28 define a first sleeve 22. This first sleeve 21 is dimensioned for receipt of the label mount backing plate 12. The area bounded laterally by the interior wall and the end of the opposing ridges 28 define an adjacent, second sleeve 26. This second sleeve 26 is dimensioned for receipt of the label plate 30.

FIG. 2 illustrates configurations of a label plate 30. The label plate 30 is composed of rigid materials, including plastics and polymers, such as rigid polyvinyl chloride, ultramid polyamide, glass-filled ultramid polyamide, or others, and is operable to display the product information on the proximate shelving 08. The label plate 30 includes a front face 32 and a display region 34. It has a thickness W4.

The display region 34 can receive a printable medium such as thin gauge printable sheet material, sticker labels, paper, cardstock, paper board, or other similar printable medium, that is printed with textual and/or graphical indicia including generalized information relating to a number of particular items being displayed on the shelf 08 to which interchangeable shelf label system 10 is attached, such as indicia indicative of brand identification, graphical designs and the like. In other configurations, it may serve as a printable medium, where it can be printed or screened upon.

As disclosed, embodiments of the present invention employ compression fit in the interchangeable label mount system 10, where the front face 32 of the label plate 30 contacts the interior wall of the label sleeve 20, the rear face of the label plate 30 contacts the front face 14 of the label mount backing plate 12, the front face 14 of the label mount backing plate 12 also contacts the ridges 24, and the rear face of the label mount backing plate 12 contacts the ledges 28.

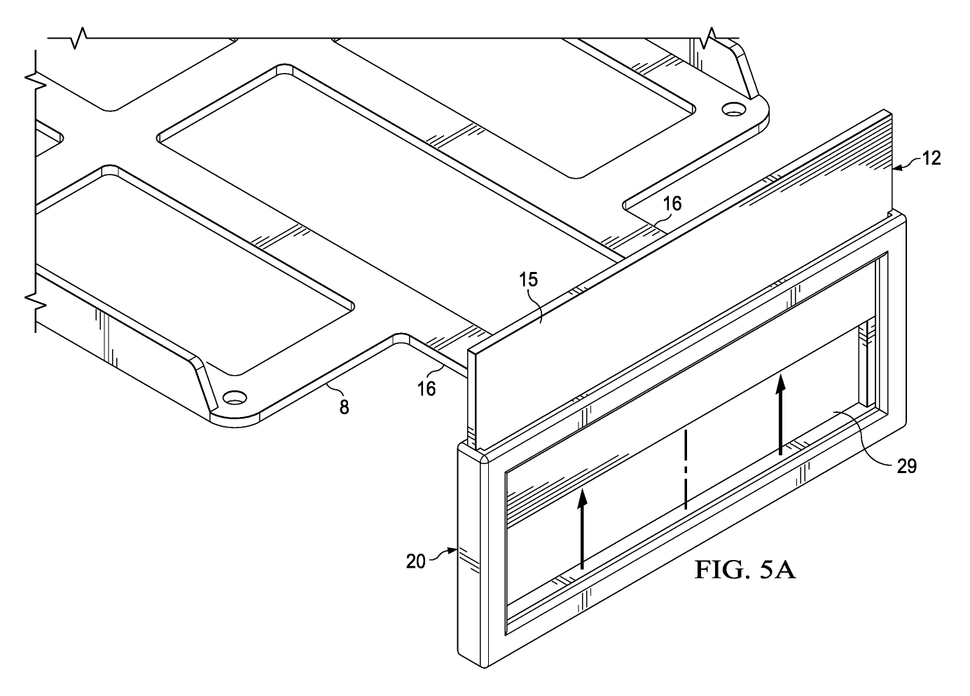

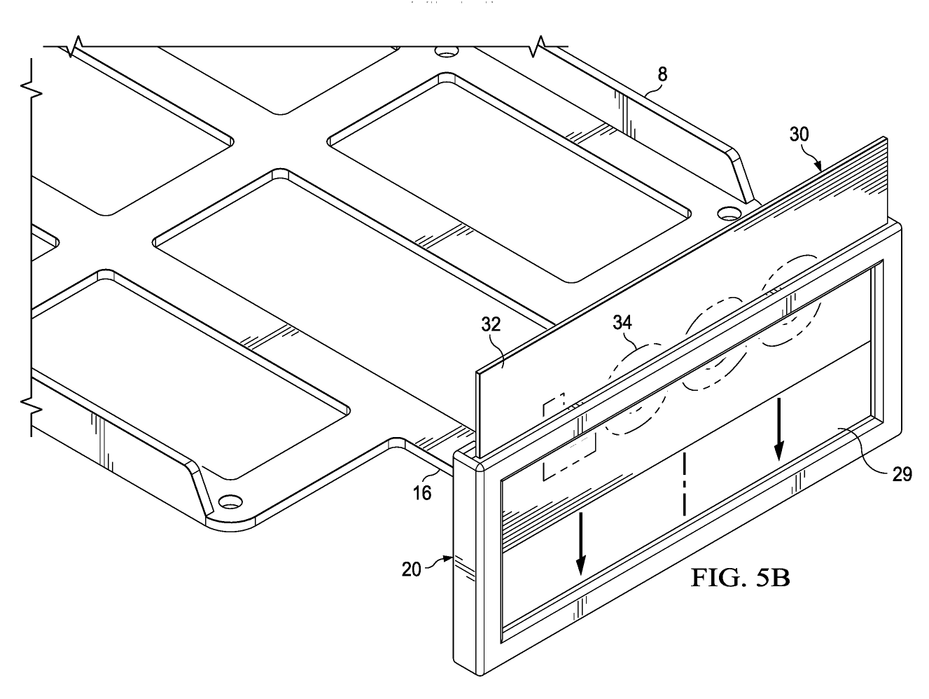

The compression of the label mount backing plate 12 and the label plate 30 within the interior of the label sleeve 20 secures the interchangeable label mount system 10 in operation (FIG. 5B). The first sleeve 22 contains the mount backing plate 12 while the second sleeve 26 contains the label plate 30. The compression is configured with a target resistance force that allows repositioning of the label plate 30 by sliding it laterally and also allows removal when necessary or desired but at the same time effectively prevents accidental dislodging of the label plate 30. In exemplary configuration, the interchangeable label mount system 10 is configured such that the label plate 30 can be removed by a user using thumbs and applying upward force to dislodge the label plate 30 for changing (FIG. 5A).

In the configuration of FIG. 4B, the label plate 30 includes one or more protrusions 18 dimensioned to be contained within a similarly positioned and dimensioned recess(es) 38 disposed on the front face 14 of the label mount plate 12 or front section 31 of the label sleeve 20, such that mating of the protrusion 18/recess 38 lock resists relative sliding of the label plate 30. In other configurations, the front face 14 of the label mount plate 12 or front section 31 of the label sleeve 20 includes one or more protrusions 18 dimensioned to be contained within similarly positioned and dimensioned recess(es) 38 disposed on the label plate 30, such that mating of the protrusion 18/recess 38 lock resists relative sliding of the label plate 30.

Referring to FIG. 3, the target configuration factors include the dimensions W1, W2, W3, and W4 and the material composition of the label sleeve 20, the label mount backing plate, and the label mount backing plate 12. Regarding the dimensions, the proportion of the values relative to each other and/or the total width can alter the target resistance or “snugness” of the fit. Regarding the material composition, materials with an optimum coefficient of friction are selected. Below are implementations for one configuration. Again, it should be appreciated that the dimension values are proportional and can be scaled for other environments.

| | Width | Composition |
|---|---|---|
| Label Mount | 3.2 mm | Glass-filled ultramid polyamide |
| Backing Plate | | |
| Thickness (W1) | | |
| First Sleeve (W2) | 3.2 mm | Glass-filled ultramid polyamide |
| Label Plate | 1.2 mm | polyvinylchloride |
| Thickness (W4) | | |
| Second Sleeve | 1.5 mm | Glass-filled ultramid polyamide |
| (W3) | | |

Another configuration employed the following:

| | Width | Composition |
|---|---|---|
| Label Mount | 2.5 mm | Glass-filled ultramid polyamide |
| Backing Plate | | |
| Thickness (W1) | | |
| First Sleeve (W2) | 2.5 mm | Glass-filled ultramid polyamide |
| Label Plate | 1.0 mm | polyvinylchloride |
| Thickness (W4) | | |
| Second Sleeve | 1.0 mm | Glass-filled ultramid polyamide |
| (W3) | | |

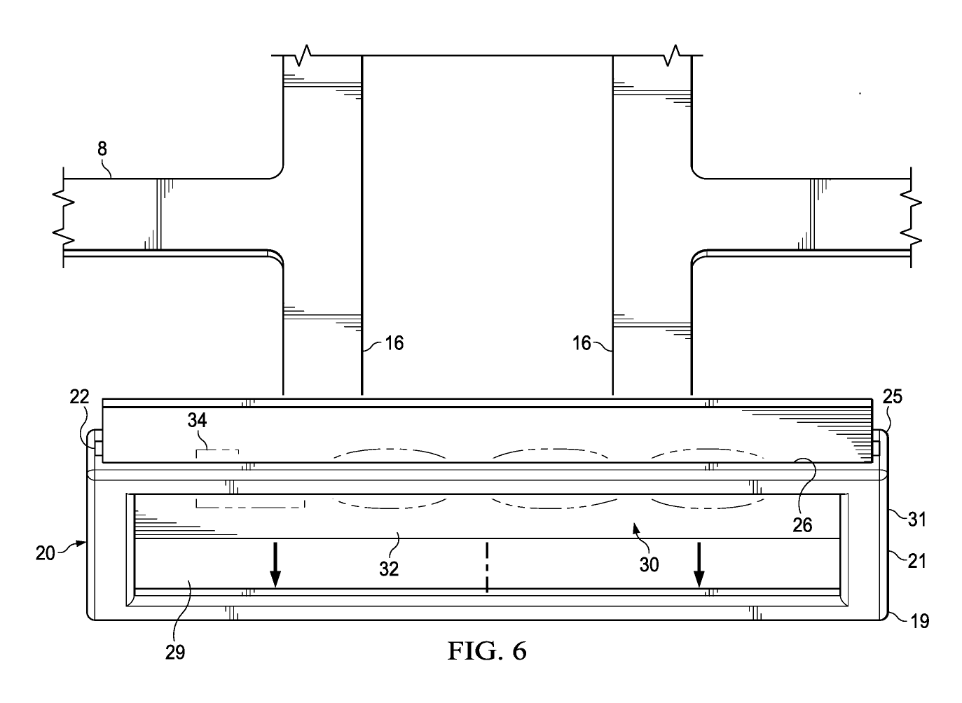

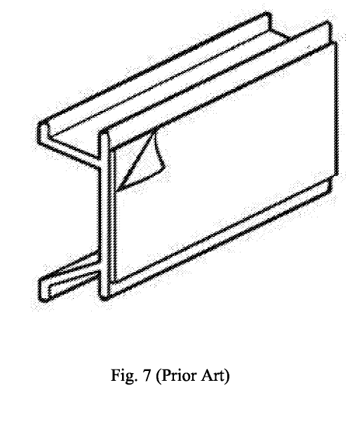

FIGS. 2, 5A, 5B, and 6 illustrate usage of an interchangeable shelf label system 10. The label mount backing plate 12, the label sleeve 20, and the label plate are brought in proximity and aligned (FIG. 2). The label sleeve 20 is slidably engaged to the label mount backing plate 12 such that the label mount backing plate 12 occupies the first sleeve 21 (FIG. 5A). The label plate 20 is slidably engaged to the label sleeve 20 such that the label plate 20 occupies the second sleeve 26 (FIG. 5B). Completely slidably engaging the label plate 30 leaves the interchangeable label mount system 10 as it would exist in shelf label display usage (FIG. 1).

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A shelf label system for securing to shelving comprising:
a label mount backing plate, a label sleeve, and a label plate;
the label mount backing plate presenting a front face as a backing surface for the label plate, the label mount backing plate having a configured width for slidable engagement in the label sleeve;
the label sleeve having an upper section, a lower section, a front section and a rear section;
the label sleeve having ridges extending inwardly to the interior of the label sleeve a configured, target length;
the label sleeve having ledges extending inwardly to the interior of the label sleeve, a configured, target length, the ledges opposing the ridges a configured, target width from the ridges;
the ledge to ridge area defining a first sleeve dimensioned for receipt of the label mount backing plate and the ridge to interior wall area defming an adjacent second sleeve dimensioned for receipt of the label plate;
the label plate including a display region and having a configured, target width; and
the configured, target widths and material compositions of the label mount backing plate, the first sleeve, the label plate, and the second sleeve selected to result in a compression fit.

2. The shelf label system of claim 1, wherein the front section of the label sleeve includes an opening presenting a window.

3. The shelf label system of claim 1, wherein the front section of the label sleeve is composed of a transparent material.

4. The shelf label system of claim 1, wherein the label mount backing plate comprises an ultramid polyamide.

5. The shelf label system of claim 1, wherein the label sleeve comprises an ultramid polyamide.

6. The shelf label system of claim 1, wherein the label plate comprises a polyvinylchloride.

7. The shelf label system of claim 1, wherein the label sleeve comprises an ultramid polyamide and the label plate comprises a polyvinylchloride.

8. The shelf label system of claim 1, wherein the label mount backing plate comprises a glass-filled ultramid polyamide, the label sleeve comprises a glass-filled ultramid polyamide, and the label plate comprises a polyvinylchloride.

9. The shelf label system of claim 1, wherein the label plate includes one or more protrusions dimensioned to be contained within a similarly positioned and dimensioned recesses disposed on the front face of the label mount plate or front section of the label sleeve, such that mating of the protrusion to recess joint resists relative sliding of the label plate.

10. The shelf label system of claim 1, wherein the front face of the label mount plate or front section of the label sleeve includes one or more protrusions dimensioned to be contained within similarly positioned and dimensioned recesses disposed on the label plate, such that mating of the protrusion to recess joint resists relative sliding of the label plate.

11. A shelf label system for securing to shelving having a label mount backing plate presenting a front face and having a known width, the shelf label system comprising:
a label sleeve, and a label plate;
the label sleeve having an upper section, a lower section, a front section and a rear section;
the label sleeve having ridges extending inwardly to the interior of the label sleeve a configured, target length;
the label sleeve having ledges extending inwardly to the interior of the label sleeve, a configured, target length, the ledges opposing the ridges a configured, target width from the ridges;
the ledge to ridge area defining a first sleeve dimensioned for receipt of the label mount backing plate and the ridge to interior wall area defming an adjacent second sleeve dimensioned for receipt of the label plate;
the label plate including a display region and having a configured, target width; and
the configured, target widths and material compositions of the label mount backing plate, the first sleeve, the label plate, and the second sleeve selected to result in a compression fit.

12. The shelf label system of claim 11, wherein the front section of the label sleeve includes an opening presenting a window.

13. The shelf label system of claim 11, wherein the front section of the label sleeve is composed of a transparent material.

14. The shelf label system of claim 11, wherein the label mount backing plate comprises an ultramid polyamide.

15. The shelf label system of claim 11, wherein the label sleeve comprises an ultramid polyamide.

16. The shelf label system of claim 11, wherein the label plate comprises a polyvinylchloride.

17. The shelf label system of claim 11, wherein the label sleeve comprises an ultramid polyamide and the label plate comprises a polyvinylchloride.

18. The shelf label system of claim 11, wherein the label mount backing plate comprises a glass-filled ultramid polyamide, the label sleeve comprises a glass-filled ultramid polyamide, and the label plate comprises a polyvinylchloride.

19. The shelf label system of claim 11, wherein the label plate includes one or more protrusions dimensioned to be contained within a similarly positioned and dimensioned recesses disposed on the front face of the label mount plate or front section of the label sleeve, such that mating of the protrusion to recess joint resists relative sliding of the label plate.

20. The shelf label system of claim 11, wherein the front face of the label mount plate or front section of the label sleeve includes one or more protrusions dimensioned to be contained within similarly positioned and dimensioned recesses disposed on the label plate, such that mating of the protrusion to recess joint resists relative sliding of the label plate.
